(19) United States
(12) Patent Application Publication
(10) Pub. No.: US 2007/0146719 A1
(43) Pub. Date: Jun. 28, 2007

(54) Scanning apparatus for optically scanning surfaces

(76) Inventor: Matthias Wedel, Nurnberg (DE)

Correspondence Address: BRINKS HOFER GILSON & LIONE, P.O. BOX 10395, CHICAGO, IL, 60610, US

(21) Appl. No.: 11/636,163

(22) Filed: Dec. 8, 2006

(30) Foreign Application Priority Data
Dec. 16, 2005 (DE) DE102005060312.2

(51) Int. Cl. G01N 21/55

(52) U.S. Cl. 356/445

(57) ABSTRACT

A scanning apparatus is provided. The scanning apparatus includes a primary radiation source. A deflection device is operative to deflect a primary beam coming from the primary beam source. A detector is operative to detect a secondary beam that is generated when the primary beam reflects from an object.

This application claims the benefit of DE 10 2005 060 312.2 filed Dec. 16, 2005, which is hereby incorporated by reference.

### BACKGROUND

The present embodiments relate to a scanning apparatus for optically scanning surfaces.

Scanning apparatuses generally operate on the basis of electromagnetic radiation and/or visible light. Scanning apparatuses are known and are used for the three-dimensional detection of objects or persons. For example, human faces are biometrically recognized by projecting an optical pattern (e.g. a multicolored striped pattern) onto the face to be detected. An optical detection device detects the pattern reflected by the face. An image processing device reconstructs a three-dimensional contour from the pattern. In medical diagnostics, scanning apparatuses based on optical light and infrared light are used to scan human or animal tissue. The scan based on optical light allows an optical 3D image to be reconstructed and visualized. Alternatively, the scan based on infrared light allows tissue previously treated with markers to be examined for the presence of diseases, for example, cancer. Marked and diseased tissue illustrates fluorescence phantoms so that reference is also made to fluorescence scan or fluorescence detection.

Conventional methods for fluorescence detection are based on recording an image based on visible light and on recording an image based on fluorescence light in alternate and rapid succession. To generate both images, the tissue to be examined is illuminated over a large surface area and the reflected light and/or the fluorescence light is mapped onto a camera chip using optics. The camera chip alternately records visible and fluorescent images.

The required optics minimizes the achievable depth of the field. For example, the fluorescence scanner must be kept precisely at a specific distance from the surface area. Each pixel of the camera sensor image a point of the scanned surface in a locally resolved manner, so that light interspersed in a diffuse manner from other points and imaging errors of the optics impair the resolution. Light does not contribute to an evaluation. Light is interspersed in a diffuse manner from each respective tissue point and thus does not fall onto the respective camera chip pixel. The signal-to-noise distance is thus impaired.

As a result of the relatively high sensitivity for scattered light, conventional methods also only allow extremely surface-proximate tissue regions to be examined, since the diffuse interspersion of reflection and fluorescence light significantly increases in tissue layers lying below the surface. The detection surface available for a surface point, for example, precisely one camera pixel, exhibits relatively small dimensions and also relatively low sensitivity. The restricted sensitivity also impairs the signal-to-noise distance.

### SUMMARY

The present embodiments may obviate one or more of the limitations of the related art. For example, in one embodiment, an apparatus for scanning surfaces based on electromagnetic radiation comprises a higher depth of field, a greater resolution, and a higher sensitivity.

In one embodiment, a scanning apparatus includes a primary radiation source, a beam deflection device, which is operative to deflect a primary beam coming from the primary beam source, and a detector, which is operative to detect a secondary beam that is generated when the primary beam hits an object.

In one embodiment, a scanning apparatus comprises an electromagnetic primary radiation source. A controllable radiation deflection device deflects a primary beam coming from the primary radiation source. A detector is operative to detect a secondary beam generated when a primary beam hits an object. An object may include any surface, for example, a surface of a body or any other obstacle in the primary beam path generating a secondary beam. In one embodiment, the object includes both a surface of a body and any other obstacle in the primary beam path generating a secondary beam. The controllable beam deflection device may include, for example, a moveable micro-mirror or a moveable prism or polygon.

In one embodiment, the use of a controllable primary beam allows one point of the object to be illuminated. Imaging-resolution is essentially determined by the extent and/or expansion of the primary beam. The primary beam bundle may determine the geometric position of the point to be imaged. In this embodiment, imaging optics and a pixilated secondary beam detector are not needed. The depth of the field is increased by foregoing the imaging optics. In one embodiment, the depth of the field is only restricted by expansion of the primary beam. In one embodiment, the distance between the scanning apparatus and the object to be scanned is variable. For example, the distance may be set at any suitable variable distance.

In one embodiment, a pixilated detector is not needed as a deflector. In this embodiment, the detector surface that detects each individual pixel may be selected to be essentially larger than the dimensions of an individual pixel. In one embodiment, the yield (signal-noise ratio) is increased and the viewing distance is increased because the diffusely reflected secondary radiation is included in the measurement. The diffusely reflected secondary radiation does not have to be included in the measurement, for example, the secondary radiation is included based on the optics.

In one embodiment, scattered radiation and fluorescence radiation may also provide information about tissue layers underlying the surface and/or being associated with the pixel. In this embodiment, for example, the depth distribution of a fluorescence marker or the tissue condition of deep lying tissue layers may be detected.

In one embodiment, in order to illuminate only one isolated imaging point, scattered radiation influences from adjacent imaging points are prevented, thereby increasing the image sharpness. Reflections of the primary radiation from the scanning environment are avoided, for example, on tools in the scanning area, as they do not outshine the overall main scanning area, but instead only affect a respective imaging point by directly appearing therein.

In one embodiment, the primary radiation source includes a laser beam source. The laser may generate a marked bundled and/or minimally expanded light primary beam.

In one embodiment, energy and/or radiation power of the primary radiation source may be adjusted. For example, the energy parameter may trigger the fluorescence radiation to be controlled at a certain predetermined parameter. The radiation power parameter enables the detection depth to be influenced.

In one embodiment, a beam converter is provided, which includes a filter. The filter allows secondary radiation of a predetermined wavelength region to occur exclusively. For example, the filter fades (filters) out the targeted visible light and exclusively allows fluorescence light to pass through. In one embodiment, a filter of this type may be used for fluorescence detection.

### BRIEF DESCRIPTION OF THE DRAWINGS

FIG. 1 illustrates one embodiment of a scanning apparatus with an image processing computer; and

FIG. 2 illustrates one embodiment of a scanning apparatus with a display device

### DETAILED DESCRIPTION

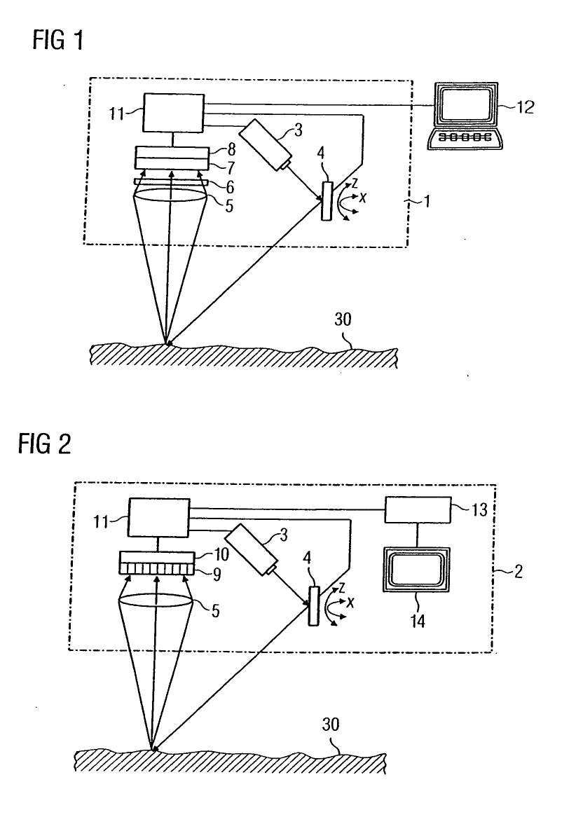

In one embodiment, as shown in FIG. 1, a scanning apparatus 1 and an image processing computer 12 are provided. In this embodiment, the surface of a body or tissue 30 is scanned by the scanning apparatus 1.

In one embodiment, the scanning apparatus 1 includes a primary beam source. The primary beam source may include, for example, a laser beam source 3. The primary beam source generates a laser beam, which is indicated as an arrow. The laser beam hits a deflection device embodied as a micromirror 4. In one embodiment, the deflection device is adjustable on two axes, for example, illustrated in FIG. 1 by double arrows denoted with x and z.

In one embodiment, the scanning apparatus 1 may be used during a medical examination, for example, cancer diagnosis, for scanning a fluorescence attribute. The laser beam source 3 may generate laser radiation of a suitable wavelength. One suitable wavelength range is between about 690 nm to 850 nm. The suitable wavelength depends on the markers used.

In one embodiment, the micro-mirror 4 deflects the laser beam such that it hits a point of the object 30 to be imaged. A secondary beam is generated at the point where the laser beam hits the object, for example, by reflection or fluorescence. In the case of reflection, the wavelength (energy) of the secondary beam essentially depends on the wavelength of the primary laser beam. Alternatively, in the case of fluorescence, the wavelength (energy) also depends to a substantial degree on the condition of the object 30. Fluorescence only occurs when a fluorescing material is stimulated in a suitable wavelength by primary radiation. In this embodiment, the wavelength of the fluorescence radiation may be specified to a substantial degree by the fluorescing material.

In one embodiment, the secondary radiation passes through a lens 5. In this embodiment, the lens 5 bundles the second radiation onto a detector surface 7. For example, the lens 5 directs the second radiation to a common point. In one embodiment, prior to hitting the detector surface 7, the second radiation bundle passes through a filter 6. The filter 6 improves the quality of the secondary radiation to be detected. For example, the filter 6 can allow secondary radiation of exclusively one wavelength range to occur, in which a fluorescence phantom to be examined appears. The filter 6 may also allow secondary radiation to occur exclusively in the wavelength range of the primary radiation. In this embodiment, for example, the interfering ambient light is faded out.

In one embodiment, secondary radiation that hits (strikes) the detector surface 7 is detected by a detector electronics assembly 8. In one embodiment, a control device 11 is operatively connected to the detector electronics assembly 8. The control device 11 reads out the detector electronics assembly 8. The control device 11 is additionally connected to the laser beam source 3, and to the micromirror 4. The control device 11 controls the generation of laser radiation, its deflection by the micro-mirror 4, and the reading out of the detector electronics assembly 8. In one embodiment, both the local information of the pixel just illuminated at the time and its detector measurement value are present in the control device 11 at any point in time. For example, all information required to reconstruct an image of the object 30 is available to the control device 11. The primary beam is rasterized in a predetermined spatial pattern and at a predetermined clock pulse. The control device 11 records individual measurement values at a predetermined clock pulse. The control device 11 outputs this information to an image processing computer 12, in which a correspondingly configured algorithm reconstructs the image of the object 30. The reconstruction algorithm may be embodied both as software or hardware, for example, graphical components. In one embodiment, the image processing computer 12 includes a conventional display device in order to optically display the scanned image.

In one embodiment, as shown in FIG. 2, a scanning apparatus 2 includes its own display device 14. In this embodiment, a laser 3 is provided as the primary beam source, the laser beam of the laser may be deflected by a micro-mirror 4. Secondary radiation is likewise bundled by a lens 5.

In one embodiment, as shown in FIG. 2, the bundled secondary radiation hits a rasterized detector surface 9. The rasterized detector surface 9 may include, for example, a CCD or camera chip. A detector electronics assembly 10 reads out the rasterized detector surface 9 and the measurement values are received by the control device 11. In one embodiment, as discussed for FIG. 1, the control device 11 also controls both the laser beam source 3 and the micro-mirror 4. The control device 11 may assign a respective detector measurement value of the local information of the respective just illuminated point of the object 30.

In one embodiment, an image processing device 13 receives information from a control device 11 and reconstructs an image of the object 30 using a suitable reconstruction algorithm. This image is displayed on the display device 14.

Various embodiments described herein can be used alone or in combination with one another. The forgoing detailed description has described only a few of the many possible implementations of the present invention. For this reason, this detailed description is intended by way of illustration, and not by way of limitation. It is only the following claims, including all equivalents that are intended to define the scope of this invention.

1. A scanning apparatus comprising:
a primary radiation source,
a deflection device, which is operative to deflect a primary beam coming from the primary radiation source, and
a detector, which is operative to detect a secondary beam that is generated when the primary beam reflects from an object.

2. The scanning apparatus as claimed in claim 1, wherein the primary radiation source comprises a laser beam source.

3. The scanning apparatus as claimed in one of claims 1, wherein energy, radiation power, or both of the primary radiation source is adjustable.

4. The scanning apparatus as claimed in claim 1, wherein the deflection device comprises a micro-mirror which is adjustable in terms of orientation.

5. The scanning apparatus as claimed in claim 1, wherein the deflection device comprises a prism which can be adjusted in terms of orientation.

6. The scanning apparatus as claimed in claim 1, further comprising a beam converter arranged upstream of the detector, wherein a secondary beam passes through the beam converter before hitting the detector.

7. The scanning apparatus as claimed in claim 6, wherein the beam converter comprises a filter, which exclusively passes secondary radiation of a predetermined wavelength range through the filter.

8. The scanning apparatus as claimed in claim 7, wherein the filter passes secondary radiation of 650 nm and 850 nm.

9. The scanning apparatus as claimed in claim 6, wherein the beam converter comprises a lens, which focuses a secondary beam bundle on the detector.

10. The scanning apparatus as claimed in claim 1, wherein the detector comprises a single sensor.

11. The scanning apparatus as claimed in claim 1, wherein the detector comprises a camera chip, a CCD chip, or both.

12. The scanning apparatus as claimed in claim 1, further comprising a control device, which is operatively coupled to the beam deflection device and to the detector.

13. The scanning apparatus as claimed in claim 12, wherein the control device is operative to control the deflection device, and wherein the primary beam is rasterized in a predetermined spatial pattern and a predetermined clock pulse.

14. The scanning apparatus as claimed in claim 13, wherein the control device is operative to control the detector, and wherein the control device records individual measurement values at a predetermined clock pulse.

15. The scanning apparatus as claimed in claim 14, wherein the control device is operative to read out the individual measurement values of the detector and feed them to an image processing device, which is designed to reconstruct an overall image from the individual measurement values as a function of the predetermined spatial grid pattern.

16. The scanning apparatus as claimed in claim 1, wherein the primary radiation source comprises an electromagnetic source.

17. The scanning apparatus as claimed in claim 1, wherein the beam deflection device is adjustable to a suitable position.

18. The scanning apparatus as claimed in claim 8, wherein the beam converter comprises a lens, which focuses a secondary beam bundle on the detector.

19. The scanning apparatus as claimed in claim 15, wherein the image processing unit is operative to reconstruct the image of the object using a reconstruction algorithm.

20. The scanning apparatus as claimed in claim 19, wherein the reconstruction algorithm may be embodied as software or hardware.
